(19) United States
(12) Patent Application Publication
(10) Pub. No.: US 2009/0025801 A1
(43) Pub. Date: Jan. 29, 2009

(54) Hydraulic system for producing a pilot pressure to actuate a transmission component

(75) Inventor: Reinhard Stehr, Buhl (DE)

Correspondence Address: ALFRED J MANGELS, 4729 CORNELL ROAD, CINCINNATI, OH, 452412433, US

(73) Assignee: LuK Lamellen und Kupplungsbau Beteiligungs KG, Buhl (DE)

(21) Appl. No.: 12/217,527

(22) Filed: Jul. 3, 2008

Related U.S. Application Data
(60) Provisional application No. 60/958,165, filed on Jul. 3, 2007.

(51) Int. Cl. F16K 31/12

(52) U.S. Cl. 137/489

(57) ABSTRACT

A hydraulic system for producing a pilot pressure to actuate at least one transmission component of an automatic transmission of a vehicle. A pilot system is connected via an inlet orifice or flow restriction to a supply conduit that is under a predetermined input pressure and that includes a pressure limiting valve for setting a predetermined pilot pressure. At least one inlet orifice or flow restriction is provided in such a way that the resulting flow resistance compensates for a rise in residual pilot pressure at low temperatures.

### BACKGROUND OF THE INVENTION

1. Field of the Invention

The present invention relates to a hydraulic system for producing a pilot pressure to actuate at least one transmission component of an automatic transmission of a vehicle. A pilot system is connected via an inlet orifice to a supply line that is under a predetermined input pressure and that includes a pressure limiting valve for setting a predetermined pilot pressure.

2. Description of the Related Art

A hydraulic system of a type for producing a pilot pressure, to actuate certain hydraulically operated transmission components in an automatic transmission, for example, is sufficiently well known in the field of automotive engineering. The hydraulic system usually includes a pilot system having one or more regulating valves that are used to set a desired pilot pressure. By using an inlet orifice connected in series with the regulating valve designed as a pressure limiting valve, which inlet orifice is normally stamped into an intermediate plate as an apertured orifice plate, a modulatable pilot pressure can be produced. That allows any pilot pressure desired to be set in the hydraulic system.

When the pilot valve or pressure reducing valve is fully opened, for example in a free flowing state, the pressure limiting valve—depending upon its design—inevitably acts because of its cross sections as a fixed flow resistance that produces a predetermined residual pilot pressure. That residual pilot pressure is highly temperature-dependent, and exceeds technically reasonable limits especially in cold conditions, i.e., at low temperatures, in particular if a screen is interposed ahead of the pressure limiting valve to protect the latter.

Because of the effect described above, a pressure range is realized in the hydraulic system—in particular at low temperatures—that cannot be used as the working range when designing the pressure limiting valve. This significantly limits the working range of the pressure limiting valve in the known hydraulic system.

Accordingly, an object of the present invention is to provide a hydraulic system of the type described at the beginning for producing a pilot pressure, wherein a rise in the residual pilot pressure is avoided, in particular at low temperatures.

### SUMMARY OF THE INVENTION

In accordance with one aspect of the present invention, a hydraulic system is provided for producing a pilot pressure to actuate at least one transmission component of an automated transmission of a vehicle. A pilot system is connected through an inlet orifice to a supply line that is under a predetermined input pressure, and a pressure limiting valve is provided to set a predetermined pilot pressure. In accordance with the invention, at least one inlet orifice is designed in such a way that the resulting flow resistance compensates for a rise in residual pilot pressure at low temperatures. Thus, the flow resistance of the inlet orifice is adjusted to the flow resistance of the pressure limiting valve at low temperatures.

With the hydraulic system in accordance with the present invention it is possible to counteract the described effect of an increase in the residual pilot pressure, so that by making structural changes to the inlet orifice, for example, the temperature behavior of the inlet orifice is adjusted to the temperature behavior of the opened pressure limiting valve. In that way the working range of the pressure limiting valve can be expanded in an especially advantageous manner, in which the lowest possible residual pilot pressure is set in the pilot system, even at low temperatures.

A possible variant design of the present invention can include the provision that the flow resistance of the inlet orifice can be increased by increasing the flow-through length of the inlet orifice. Thus, the flow resistance of the inlet orifice is increased because of the higher oil viscosity at low temperatures. In that way an adjustment of the inlet orifice to the temperature dependency of the pressure limiting valve can be enabled by means of simple design measures, without changes to the complexly constructed pressure limiting valve. The adaptation of the form of the inlet orifice in accordance with the invention makes it possible to realize a reduction in the temperature dependence of the residual pilot pressure in the pilot system.

By increasing the flow resistance at the inlet orifice, the pressure behind the inlet orifice—i.e., the pilot pressure—can be reduced, in order to counteract a rise in the residual pilot pressure with the pressure limiting valve open, in particular at low outside temperatures.

A possible design configuration of the invention can provide that the inlet orifice, as a bore or the like having a predetermined length, is situated in a housing or the like of the pilot system in the hydraulic system in accordance with the invention. That enables the proposed increase in the flow-through length of the inlet orifice to be realized in an extremely simple manner. Design configurations are also conceivable that effect an increase in the flow-through length of the inlet orifice to increase the resistance. For example, the inlet orifice with its bore can also be accommodated in the housing of the pressure limiting valve.

The options for situating the bore are diverse. For example, the bore can be oriented coaxially with or parallel to the longitudinal axis of the pressure limiting valve. It is also possible for the bore to be situated transversely or at some other angle to the longitudinal axis of the pressure limiting valve.

If the bore of the inlet orifice is situated in a housing, it is advantageous if the housing is made of cast iron or the like. That represents an especially simple manner of production in terms of manufacturing technology.

To increase the flow resistance at the inlet orifice, a further refinement of the invention can also include the provision for a plurality of inlet orifices to be connected in a series in order to increase the flow-through length. For example, the inlet orifices can be punched as plate orifices in an intermediate plate of the pilot system.

Because of the inlet orifices connected in series, the flow resistance can remain unchanged at normal temperatures, while at low temperatures the flow resistance is effectively increased due to the greater length used. Thus, in this version as well, a reduction in the residual pilot pressure at low temperatures can be realized by increasing the flow resistance at the inlet orifice.

A preferred variant design of the present invention can provide that a proportional valve with a screen inserted upstream for protection against fouling be used as the pressure limiting valve.

Preferably, the proposed hydraulic system for producing a pilot pressure can be employed as a pilot pressure control system in a CVT transmission. However, other areas of application are also conceivable.

### BRIEF DESCRIPTION OF THE DRAWINGS

The structure, operation, and advantages of the present invention will become further apparent upon consideration of the following description, taken in conjunction with the accompanying drawings in which:

FIG. 1 is a partial sectional view of a first exemplary embodiment of a hydraulic system in accordance with the invention, with a proportional solenoid valve as the pressure limiting valve;

FIG. 2 is a partial sectional view of a second exemplary embodiment of a hydraulic system in accordance with the present invention; and

FIG. 3 is a partial sectional view of a third exemplary embodiment of a hydraulic system in accordance with the present invention.

### DESCRIPTION OF THE PREFERRED EMBODIMENTS

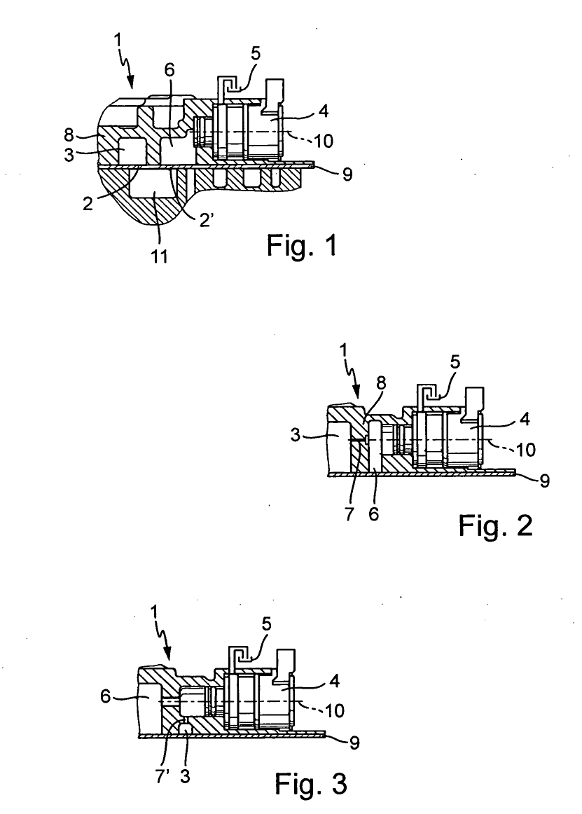

FIGS. 1 through 3 show various exemplary embodiments in accordance with the present invention of a hydraulic system for producing a pilot pressure to actuate at least one transmission component of an automatic transmission of a vehicle.

The hydraulic system for producing a pilot pressure includes a pilot system 1 that is situated in a cast iron housing 8. Pilot system 1 includes a pressure limiting valve which, in the illustrated exemplary embodiments, is designed as a proportional solenoid valve 4. Proportional solenoid valve 4 is connected on the one hand with a pilot pressure conduit 6, and on the other hand with a tank 5 into which any leakage flow that occurs is diverted. A screen is inserted upstream of proportional solenoid valve 4 to protect it against contamination.

In order to be able to set a desired pilot pressure, pilot pressure conduit 6 is supplied with oil through a supply conduit 3 that is at a predetermined input pressure. The input pressure is around 5 bar.

The exemplary embodiment illustrated in FIG. 1 shows the hydraulic system in accordance with the present invention with two inlet orifices in series. The inlet orifices in FIG. 1 are in the form of plate orifices 2, 2′. The plate orifices 2, 2′ are formed in an intermediate plate 9 by stamping in an extremely simple manner. Intermediate plate 9 is attached to housing 8 of pilot system 1.

The first plate orifice 2 connects supply conduit 3 with an intermediate chamber 11, while the second plate orifice 2′ connects intermediate chamber 11 with pilot pressure conduit 6, which supplies a transmission component (not shown) with a pilot pressure. To set a desired pilot pressure, a connection of proportional solenoid valve 4 branches off from pilot pressure conduit 6.

Thus, in accordance with the present invention, the first exemplary embodiment of the proposed hydraulic system provides that the flow resistance is increased by extending the flow-through length because of the plate orifices 2, 2′ connected in series, in order to achieve a reduction of the residual pilot pressure. Hence the desired effect can be achieved by extremely simple design means.

FIG. 2 shows a second exemplary embodiment of the present invention, in which a narrow bore 7 is provided in housing 8 of the hydraulic system as the inlet orifice or flow restriction. In this exemplary embodiment as well, the flow-through length is increased by an inlet orifice in order to ultimately lower the residual pilot pressure at low temperatures in the supply system.

Bore 7 is supplied at one end with the input pressure by way of supply conduit 3. On its other end, bore 7 is in communication with proportional solenoid valve 4 to set a desired pilot pressure. In this second exemplary embodiment, bore 7 is oriented coaxially with the longitudinal axis 10 of proportional solenoid valve 4 in housing 8 of pilot system 1.

Finally, FIG. 3 shows a third exemplary embodiment of the hydraulic system in accordance with the present invention. In this exemplary embodiment also, a bore 7′ is provided in housing 8 of pilot system 1 as the inlet orifice. However, bore 7′ is oriented transversely to the longitudinal axis 10 of proportional solenoid valve 4. Here too, the flow-through length is extended to increase the resistance, in order to prevent an undesired increase of the residual pilot pressure, particularly at low temperatures.

Although particular embodiments of the present invention have been illustrated and described, it will be apparent to those skilled in the art that various changes and modifications can be made without departing from the spirit of the present invention. It is therefore intended to encompass within the appended claims all such changes and modifications that fall within the scope of the present invention.

What is claimed is:

1. A hydraulic system for producing a pilot pressure to actuate at least one transmission component of an automatic transmission of a vehicle, said hydraulic system comprising: a pilot pressure system that is connected via an inlet flow restriction to a supply conduit that is at a predetermined input pressure, a pressure limiting valve in communication with the inlet flow restriction for setting a predetermined pilot pressure, wherein the flow restriction is formed so that a resulting inlet flow resistance compensates for a rise in residual pilot pressure at low temperatures.

2. A hydraulic system in accordance with claim 1, wherein the inlet flow restriction has a flow-through length sufficient to reduce the residual pilot pressure at low temperatures.

3. A hydraulic system in accordance with claim 1, wherein the inlet flow restriction is included in a housing containing the pressure pilot system and is a bore having a predetermined length.

4. A hydraulic system in accordance with claim 3, wherein the bore has an axis that is oriented transversely to a longitudinal axis of the pressure limiting valve.

5. A hydraulic system in accordance with claim 3, wherein the bore has an axis that is oriented coaxially to a longitudinal axis of the pressure limiting valve.

6. A hydraulic system in accordance with claim 3, wherein the housing is made of cast iron.

7. A hydraulic system in accordance with claim 1, wherein the flow restriction includes a plurality of inlet orifices connected in series for increasing flow-through length of the pilot pressure system.

8. A hydraulic system in accordance with claim 7, wherein the inlet flow restriction includes at least two orifices that are formed by stamping an intermediate plate that is connected to the housing.

9. A hydraulic system in accordance with claim 1, wherein the pressure limiting valve is a proportional solenoid valve.

10. A hydraulic system in accordance with claim 1, wherein the hydraulic system is a pilot pressure system of a CVT transmission.

11. A hydraulic system in accordance with claim 9, including a screen positioned upstream of the proportional solenoid valve.
